(19) United States
(12) Patent Application Publication
(10) Pub. No.: US 2024/0244679 A1
(43) Pub. Date: Jul. 18, 2024

(54) METHOD PERFORMED BY USER EQUIPMENT, AND USER EQUIPMENT

(71) Applicant: SHARP KABUSHIKI KAISHA, SaKai City , Osaka (JP)

(72) Inventors: CHONGMING ZHANG, Shanghai (CN); RENMAO LIU, Shanghai (CN)

(21) Appl. No.: 18/574,121

(22) PCT Filed: Jul. 6, 2022
(86) PCT No.: PCT/CN2022/104121

§ 371 Date: Dec. 26, 2023

(30) Foreign Application Priority Data
Jul. 9, 2021 (CN) 202110781784.6

(51) Int. Cl. H04W 76/10

(52) U.S. Cl. CPC H04W 76/10

(57) ABSTRACT

Provided in the present invention are a method performed by user equipment, and user equipment. The method includes the following steps: receiving, by relay UE, an indication from an upper layer, information in the indication including information that an established PC5 RRC connection is used for a relay or a relay service, or information in the indication indicating that a PC5 RRC connection has been established for a dedicated destination address and that the connection is used for a relay or a relay service; and performing, by the relay UE on the basis of the indication or upon receiving the indication, the following an operation of establishing a PC5 RLC bearer, establishing a PC5 RLC entity, or establishing a corresponding logical channel, wherein the established PC5 RLC bearer, PC5 RLC entity, or logical channel is used to bear an SRB0 message, or to bear a message transmitted using a logical channel of a dedicated logical channel category.

### TECHNICAL FIELD

The present invention relates to the technical field of wireless communications. More specifically, the present invention relates to a method for RLC in a sidelink relay architecture performed by user equipment, and corresponding user equipment.

### BACKGROUND

At the 3rd Generation Partnership Project (3GPP) RAN #80 plenary meeting in June 2018, the subject of the study on the feasibility of V2X based on 5G NR network technology of Release 16 (see non-patent literature: RP-181480, New SID Proposal: Study on NR V2X) was approved. The primary function included in NR V2X of Release 16 is to support unicast, multicast, and broadcast in out-of-coverage and in-coverage scenarios.

At the RAN #86 plenary meeting in December 2019, a study item on NR sidelink relaying of Release 17 was proposed (see non-patent literature: RP-193253, New Study Item on NR Sidelink Relaying), and was approved. Regarding the latest release of the study item, see non-patent literature: RP-201474, Revised SID: NR Sidelink Relay. The study item mainly studies the solution to user equipment (UE)-to-network and UE-to-UE relaying, for extending sidelink-based coverage. One of the goals of the study item is to support a sidelink control plane procedure.

At the RAN #91 plenary meeting in March 2020, a study item on NR sidelink relaying of Release 17 was proposed (see non-patent literature: RP-210904, New Study Item on NR Sidelink Relaying), and was approved. One of the goals of the work item is to standardize a sidelink control plane procedure, such as management of an RRC connection.

As shown in FIG. 1, UE may directly establish an RRC connection to a base station (gNB) via a Uu interface. The UE transmits an RRC connection establishment request message to the base station via SRB0. SRB0 is for RRC messages using the CCCH logical channel. The RRC message transmitted on SRB0 may simply be referred to as an SRB0 message.

As shown in FIG. 2, UE may also establish an RRC connection to a base station (gNB) via relay UE. Such UE may be referred to as remote UE. The remote UE and the relay UE communicate with each other via sidelink, and a sidelink link communication interface is a PC5 interface. The relay UE and the base station still use a Uu interface for communication therebetween.

In order to establish an RRC connection to the base station, the remote UE also needs to transmit an SRB0 message. Since the remote UE establishes a connection to the base station via the relay UE, in the protocol architecture, an RLC entity associated with the foregoing SRB0 is a PC5 RLC entity.

In sidelink communication, upon a transmitting UE side being configured with an RLC entity, information reception can be achieved only when the same configuration information is also used on a receiving UE side to configure a peer RLC entity. The present invention discusses RLC entity establishment and management of remote UE and relay UE in an RRC connection management procedure in order to transmit an SRB0 message.

### SUMMARY

In order to address the aforementioned issue, the present invention provides a method performed by user equipment and user equipment.

According to an aspect of the present invention, provided is a method performed by user equipment, being a method wherein remote UE and relay UE establish and manage an RLC bearer/entity/channel in an RRC connection management procedure, comprising the following steps:
receiving, by the relay UE, an indication from an upper layer, information in the indication comprising information that an established PC5 RRC connection is used for a relay or a relay service, or information in the indication indicating that a PC5 RRC connection has been established for a dedicated destination address and that the connection is used for a relay or a relay service; and
performing, by the relay UE on the basis of the indication or upon receiving the indication, the following operation:
   establishing a PC5 RLC bearer;
   establishing a PC5 RLC entity; or
   establishing a corresponding logical channel,
wherein the established PC5 RLC bearer, PC5 RLC entity, or logical channel is used to bear an SRB0 message, or to bear a message transmitted using a logical channel of a dedicated logical channel category.

In the above-described method performed by user equipment, preferably, the established PC5 RLC bearer, PC5 RLC entity, or logical channel belongs to a specific sidelink SRB or sidelink DRB, or is associated with a specific sidelink SRB or sidelink DRB.

In the above-described method performed by user equipment, preferably, the above-described specific sidelink SRB or sidelink DRB is a default sidelink SRB or sidelink DRB, and is used to bear an SRB0 message, or to bear a message transmitted using a logical channel of a dedicated logical channel category.

In the above-described method performed by user equipment, preferably,
the established PC5 RLC bearer, PC5 RLC entity, or logical channel uses a default configuration to configure a PC5 RLC bearer, a PC5 RLC entity, or a logical channel for bearing/transmission of an SRB0 message.

In the foregoing method performed by user equipment, preferably, the following steps are further comprised:
receiving, by the relay UE, a PC5 RRC message transmitted from the remote UE, the message carrying a relay service request or relay-related information; and performing, by the relay UE on the basis of the message or upon receiving the message, the above-described operation.

In the foregoing method performed by user equipment, preferably, the following step is further comprised:
further establishing, by the relay UE, a Uu RLC entity, and associating the Uu RLC entity with the established PC5 RLC entity,
wherein the Uu RLC entity is used to transmit an SRB0 message from the remote UE.

In the foregoing method performed by user equipment, preferably, the following steps are further comprised:
receiving, by the remote UE, an indication from an upper layer, information in the indication comprising information that an established PC5 RRC connection is used for a relay or a relay service, or information in the indication indicating that a PC5 RRC connection has been established for a dedicated destination address and that the connection is used for a relay or a relay service; and
performing, by the remote UE on the basis of the indication or upon receiving the indication, the above-described operation.

In the above-described method performed by user equipment, preferably,
if the PC5 RLC bearer has been established, the PC5 RLC bearer is re-established; and
if the PC5 RLC entity has been established, the PC5 RLC entity is re-established.

According to another aspect of the present invention, user equipment is provided, comprising:
a processor; and
a memory storing instructions, wherein
the instructions, when run by the processor, causing the user equipment to perform the method described above.

The method performed by user equipment and corresponding user equipment according to the present invention can reliably establish and manage an RLC entity in an RRC connection management procedure.

### BRIEF DESCRIPTION OF THE DRAWINGS

FIG. 1 is a schematic diagram showing that UE directly establishes an RRC connection to a base station via a Uu interface.

FIG. 2 is a schematic diagram showing that UE establishes an RRC connection to a base station via relay UE.

FIG. 3 is a schematic diagram showing UE-to-network relay.

FIG. 4 is a schematic diagram showing control plane protocol stacks of a UE-to-network L2 architecture.

FIG. 5 is a flowchart showing a method performed by user equipment (UE).

FIG. 6 is a simplified structural block diagram of user equipment (UE) according to the present invention.

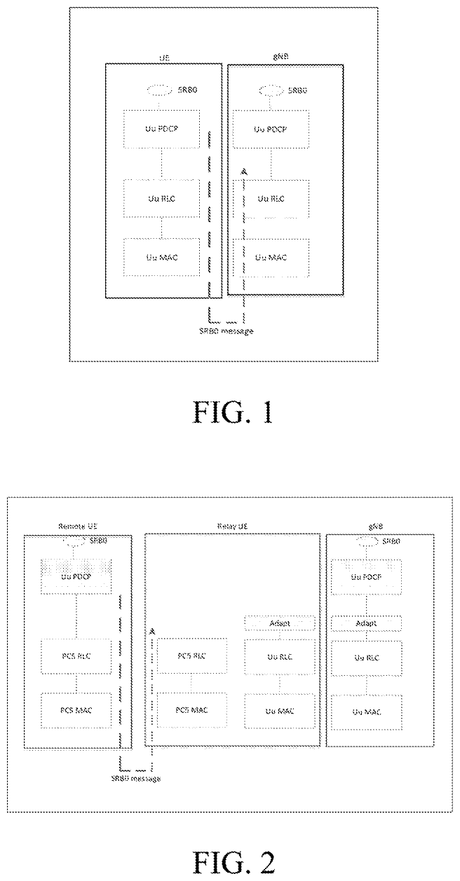

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The following describes some terms involved in the present invention. For the specific meanings of the terms, please see the latest 3GPP standards and specifications.
UE: User Equipment
NR: New Radio
MAC: Medium Access Control
MAC CE: MAC control element
RLC: Radio Link Control
SDAP: Service Data Adaptation Protocol
PDCP: Packet Data Convergence Protocol
RRC: Radio Resource Control
RRC_CONNECTED: RRC connected state
RRC_INACTIVE: RRC inactive state
RRC_IDLE: RRC idle state
RAN: Radio Access Network
Sidelink: sidelink communication
SCI: Sidelink Control Information
AS: Access Stratum
IE: Information Element
CE: Control Element
MIB: Master Information Block
NR: New Radio
UMTS: Universal Mobile Telecommunications System
E-UTRAN: Evolved UMTS Terrestrial Radio Access Network
SIB: System Information Block
NG-RAN: NG Radio Access Network
DCI: Downlink Control Information
ADAPT: adaptation layer
PHY: physical layer
RB: Radio Bearer
DRB: Data Radio Bearer
SRB: Signaling Radio Bearer
PDU: Protocol Data Unit
SDU: Service Data Unit
V2X: Vehicle-to-Everything
Enb: evolved node base station
Gnb: new generation node base station
CCCH: Common Control Channel
DCCH: Dedicated Control Channel

In the present invention, a network, a base station, and a RAN may be used interchangeably. The network may be a Long Term Evolution (LTE) network, a new RAT (NR) network, an enhanced Long Term Evolution (eLTE) network, or another network defined in a subsequent evolved version of the 3GPP.

In the present invention, user equipment (UE) may refer to an NR device that supports an NR sidelink relay function as described in the background, may also refer to an NR device that supports an NR sidelink relay architecture, and may also refer to an NR device or an LTE device of another type.

In the present invention, sidelink and PC5 may be used interchangeably, and an RLC channel, an RLC entity, and an RLC bearer may be used interchangeably.

Hereinafter, a description will be given of related art of the present invention.

A PC5 interface is an interface for performing control plane and user plane sidelink communication between UE and UE. For sidelink unicast, a PC5-RRC connection is an AS layer logical connection between a pair of a source layer-2 ID and a target layer-2 ID. Establishment of one PC5 unicast link corresponds to establishment of one PC5-RRC connection.

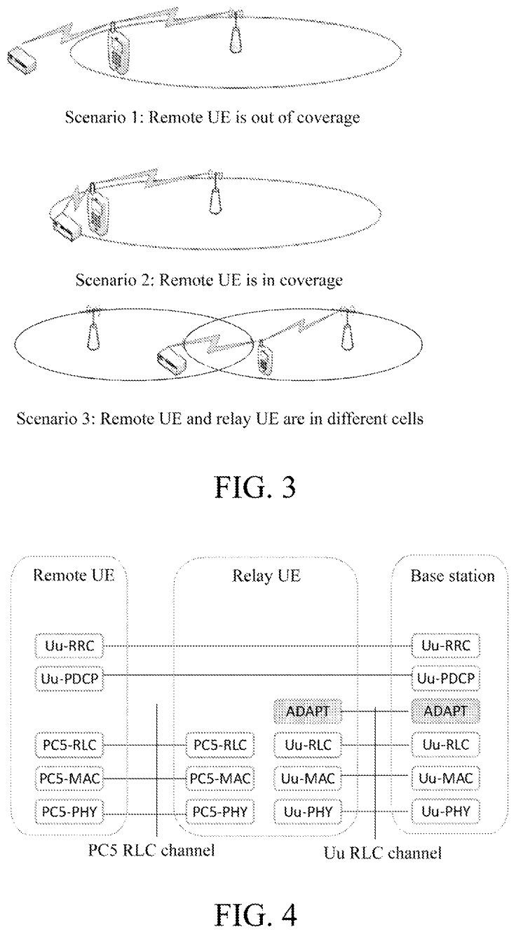

UE-to-network relaying is as shown in FIG. 3. In scenario 1 and scenario 2, the left side is remote UE, the middle is relay UE, and the right side is a network. In scenario 3, both sides are networks, and the middle, from left to right, is remote UE and relay UE, respectively. The remote UE and the relay UE are connected to each other by means of a PC5 interface, and the relay UE is connected to the network by means of a Uu interface. Because the remote UE is far from the network or because the communication environment is poor, the relay UE is needed to relay and forward signaling and data between the remote UE and the network.

UE-to-network relay scenarios include:
1) the remote UE is out of coverage, and the relay UE is in coverage;
2) the remote UE and the relay UE are both in coverage, and are in the same cell; and
3) the remote UE and the relay UE are both in coverage, but are in different cells.

For a sidelink layer-2 (L2) relay architecture, control plane protocol stacks of remote UE, relay UE, and a base station are as shown in FIG. 4.

After the remote UE selects a relay UE to provide a relay service for the remote UE, the remote UE will establish a PC5-RRC connection to the relay UE, so as to communicate with the network/base station via the relay UE. The remote UE can establish an air interface RRC connection to the network via the relay UE for data transmission between the remote UE and the network. The remote UE encapsulates, via the Uu PDCP layer, data of messages to the network for air interface RRC connection setup, re-establishment, resume, etc., and then submits same to a PC5 RLC entity to be further encapsulated, borne on a PC5 RLC channel, and submitted downwards layer by layer via PC5-MAC and PC5-PHY. Upon receiving the data, the relay UE submits same upwards layer by layer via PC5-PHY and PC5-MAC. The relay UE finds, via a mapping relationship between a PC5 RLC channel and a Uu RLC channel, the Uu RLC channel bearing the message, encapsulates the message in a Uu message/data, and transmits same to the network. In turn, an RRC message returned by the network is encapsulated by the base station in a Uu message/data and transmitted to the relay UE. The relay UE finds, via a mapping relationship between a PC5 RLC channel and a Uu RLC channel, the PC5 RLC channel bearing the message, encapsulates the message in a PC5 message/data, and transmits same to the remote UE. When the remote UE initiates, to the network, procedures such as RRC connection establishment, re-establishment, and resume, a corresponding PC5 RLC entity needs to be promptly established and managed between transmitting UE (remote UE) and receiving UE (relay UE) over the PC5 interface in order to correctly receive and process data.

### SRB0 Message

Over the Uu interface, the UE transmits an RRC connection establishment request message, an RRC connection re-establishment request message, and an RRC connection resume request message to the base station via SRB0. SRB0 is for RRC messages using the CCCH logical channel. It can be seen that the RRC connection establishment request message, the RRC connection re-establishment request, and the RRC connection resume request message are all RRC messages using the CCCH logical channel. Herein, the RRC message transmitted on SRB0 may simply be referred to as an SRB0 message.

### PC5 Interface

A wireless communication interface between remote UE and relay UE. The remote UE and the relay UE communicate with each other via sidelink, and a sidelink communication interface is a PC5 interface. Therefore, the description of the sidelink and the description of PC5 are interchangeable herein.

The PC5 RLC entity refers to an RLC entity for PC5 interface communication.

### Uu Interface

A wireless communication interface between UE and a base station. The UE may communicate with eNB over the Uu interface by using an E-UTRAN. The UE may also communicate with gNB over the Uu interface by using NR.

The Uu RLC entity refers to an RLC entity for Uu interface communication.

In essence, the PC5 RLC entity and the Uu RCL entity both refer to an RLC entity that follows an RLC protocol stack, but are used for different communication interfaces.

According to the present invention, remote UE and relay UE may correctly process PC5 RLC and Uu RLC in a procedure related to an air interface RRC connection between the remote UE and a base station, thereby achieving correct setting of variables of the RLC layer in procedures such as air interface RRC connection establishment, ensuring the correctness of data transmission, and avoiding a procedure exception.

Hereinafter, several embodiments of the present invention for addressing the above problems are described in detail.

### Example 1

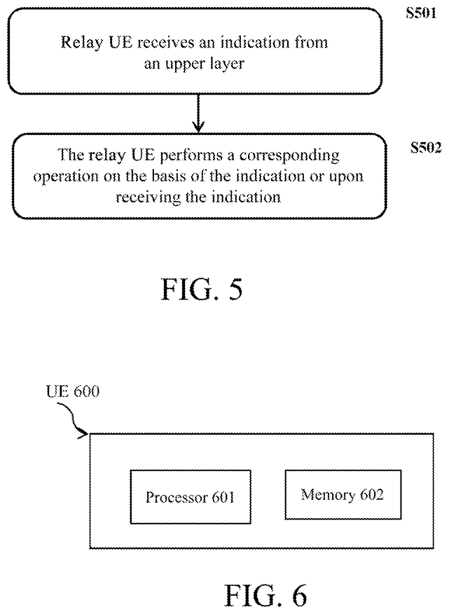

Provided in the present example is a method performed by UE, being a method wherein remote UE and relay UE establish and manage an RLC bearer/RLC entity/RLC channel in an RRC connection management procedure. As shown in FIG. 5, the method includes the following steps:
step S501: receiving, by relay UE, an indication from an upper layer, information in the indication including information that an established PC5 RRC connection is used for a relay or a relay service,
or
the indication information indicating that a PC5 RRC connection has been established for a dedicated destination address and that the connection is used for a relay or a relay service.

Step S502: performing, by the relay UE on the basis of the indication or upon receiving such an indication, one or a plurality of the following operations:
establishing an RLC bearer, the RLC bearer being preferably a PC5 RLC bearer for a PC5 interface;
establishing an RLC entity, the RLC entity being preferably a PC5 RLC entity for a PC5 interface; and establishing a corresponding logical channel, the logical channel being preferably a logical channel for sidelink communication or a PC5 interface.

The established RLC bearer or RLC entity, and the logical channel are used to bear an SRB0 message, or to bear a message transmitted using a logical channel of a dedicated logical channel category (e.g., a CCCH), or are used for SRB0 transmission via relay.

Optionally, the RLC bearer/RLC entity and the logical channel established herein may belong to a specific sidelink SRB or sidelink DRB, or may be associated with a specific sidelink SRB or sidelink DRB.

Preferably, such a specific sidelink SRB/DRB is a default sidelink SRB/DRB, and is used to bear an SRB0 message, or to bear a message transmitted using a logical channel of a dedicated logical channel category (e.g., a CCCH), or is used for SRB0 transmission via relay. Preferably, the established RLC bearer/RLC entity and logical channel described above may use a default configuration. The default configuration may be used to configure an RLC bearer/RLC entity and a logical channel for bearing/transmission of an SRB0 message. The default configuration may also be the configuration for bearing/transmission of an SRB0 message, or the configuration for SRB0 transmission on PC5/sidelink, or the configuration for SRB0 transmission via relay.

Such configuration information may include at least an RLC entity mode, a priority of the logical channel, a logical channel group number, etc. For example, the value of the RLC entity mode is the transparent mode (TM). The value of the priority of the logical channel is 1. The value of the logical channel group number is 0. On the basis of such configuration information, the relay UE may establish an RLC entity/bearer and a logical channel that uses such configuration information.

Another embodiment of the foregoing solution may be as follows:
the relay UE establishes a specific sidelink SRB or sidelink DRB on the basis of the indication or upon receiving such an indication. The specific sidelink SRB or sidelink DRB is to be used to bear an SRB0 message, or to bear a message transmitted using a logical channel of a dedicated logical channel category (e.g., a CCCH).

In a procedure of establishing the specific sidelink SRB or sidelink DRB, one or a plurality of the following operation may be included:
establishing an RLC bearer, the RLC bearer being preferably a PC5 RLC bearer for a PC5 interface;
establishing an RLC entity, the RLC entity being preferably a PC5 RLC entity for a PC5 interface; and
establishing a corresponding logical channel, the logical channel being preferably a logical channel for sidelink communication or a PC5 interface.

Another embodiment of the foregoing solution may also be as follows:
the relay UE applies a default configuration on the basis of the indication or upon receiving such an indication.

Preferably, the configuration is for bearing/transmitting an SRB0 message, or the configuration is for SRB0 transmission on PC5/sidelink, or the configuration is for SRB0 transmission via relay.

In a procedure of applying the configuration, one or a plurality of the following operations may be included:
establishing an RLC bearer, the RLC bearer being preferably a PC5 RLC bearer for a PC5 interface;
establishing an RLC entity, the RLC entity being preferably a PC5 RLC entity for a PC5 interface; and
establishing a corresponding logical channel, the logical channel being preferably a logical channel for sidelink communication or a PC5 interface.

### Example 2

Example 2 differs from Example 1 in that,
if the relay UE receives a PC5 RRC message transmitted from the remote UE, and the message carries a relay service request, or a relay-service-related request, or relay-related information,
then the relay UE performs the operations in Example 1 on the basis of the received message or upon receiving the message, which specifically may include all of the embodiments in Example 1.

Example 2 may be implemented separately to achieve the purpose of establishing a PC5 RLC entity on the relay side.

### Example 3

On the basis of Example 1 or 2, the relay UE may further establish a Uu RLC entity in addition to establishing a PC5 RLC entity/bearer, and associate the Uu RLC entity with the established PC5 RLC entity. Preferably, a mapping relationship between the Uu RLC entity and the PC5 RLC entity may be established or stored in an adaptation layer of the relay UE.

The Uu RLC entity is used to transmit, between the relay UE and a base station, an SRB0 message that is from the remote UE and transmitted to the base station.

Optionally, the Uu RLC entity may be associated with a dedicated destination address, so that the PC5 RLC entity is in a one-to-one correspondence with the Uu RLC entity.

In addition, the relay UE may also associate the established PC5 RLC entity with an established, common Uu RLC entity. That is, the common Uu RLC entity may serve a plurality of remote UEs, and be used for transmission an SRB0 message of at least one remote UE.

### Example 4

The operations in Example 1 may also be performed on the remote UE side.

A specific embodiment may be as follows:
upon the remote UE initiating an RRC connection establishment procedure, or an RRC connection resume procedure, or an RRC connection re-establishment procedure, the operations in Example 1 are performed, which may specifically include all of the embodiments in Example 1.

For example, when the remote UE initiates an RRC connection establishment procedure, the operation of establishing an RLC entity/bearer/a logical channel is performed. Alternatively, when the remote UE initiates an RRC connection establishment procedure, a specific sidelink SRB or sidelink DRB is established. Alternatively, when the remote UE initiates an RRC connection establishment procedure, a default configuration for SRB0 message bearing/transmission is applied.

Optionally, upon the UE determining that RRC connection to the network/base station is performed via the relay UE, the above operations are performed. Otherwise, if the UE establishes an RRC connection to the base station directly via a Uu interface, the above operations are not required.

A specific embodiment may also be as follows:
upon the remote UE receiving an indication from an upper layer, information in the indication may include information that an established PC5 RRC connection is used for a relay or a relay service,
or
the indication information indicates that a PC5 RRC connection has been established for a dedicated destination address and that the connection is used for a relay or a relay service.

The remote UE performs the operations in Example 1 on the basis of the indication or upon receiving the indication, which may specifically include all of the embodiments in Example 1.

### Example 5

In the operations of the foregoing example, if the PC5 RLC bearer has been established, the UE may re-establish the PC5 RLC bearer, and if the PC5 RLC entity has been established, the UE may re-establish the PC5 RLC entity.

Establishment of an RLC entity may at least include:
establishing an RLC entity; and
setting a state variable of the RLC entity to an initial value.

Re-establishment of an RLC entity may at least include:
discarding all RLC SDUs, RLC SDU segments, and RLC PDUs;
stopping and resetting all timers; and
resetting the state variable of the RLC entity to an initial value.

### Example 6

The upper layer mentioned in the foregoing examples may refer to a V2X layer, i.e., a non-access stratum/management layer responsible for the UE performing PC5 interface communication or sidelink communication, or may be a management control layer above PC5 RRC.

Such an upper layer may also specifically be a V2X application server, and indication information is provided to the lower layer of the UE by such a server.

Such an upper layer may also be a specific application layer, such as a V2X application layer, or a relay service application layer, etc.

FIG. 6 is a simplified structural block diagram of user equipment (UE) according to the present invention. As shown in FIG. 6, the user equipment (UE) 600 includes a processor 601 and a memory 602. The processor 601 may include, for example, a microprocessor, a microcontroller, an embedded processor, and the like. The memory 602 may include, for example, a volatile memory (such as a random access memory (RAM)), a hard disk drive (HDD), a non-volatile memory (such as a flash memory), or other memories. The memory 602 stores program instructions. The instructions, when run by the processor 601, can perform the above method performed by user equipment as described in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. User equipment (UE), comprising:
a processor; and
a memory in electronic communication with the processor,
wherein instructions stored in the memory are executable to:
apply, upon initiating a Radio Resource Control (RRC) establishment procedure, a default configuration used for a Radio Link Control (RLC) bearer to transmit a Signaling Radio Bearer 0 (SRB0) message via a relay UE, wherein the default configuration includes a configuration of an RLC mode, a value of logical channel group and a value of priority.

12. The UE according to claim 11, wherein the instructions stored in the memory are further executable to:
apply, upon initiating an RRC connection resume procedure, the default configuration used for the RLC bearer to transmit the SRB0 message via the relay UE.

13. The UE according to claim 11, wherein the instructions stored in the memory are further executable to:
apply, upon initiating an RRC connection reestablishment procedure, the default configuration used for the RLC bearer to transmit the SRB0 message via the relay UE.

14. A method performed by user equipment (UE), the method comprising:
applying, upon initiating a Radio Resource Control (RRC) establishment procedure, a default configuration used for a Radio Link Control (RLC) bearer to transmit a Signaling Radio Bearer 0 (SRB0) message via a relay UE, wherein the default configuration includes a configuration of an RLC mode, a value of logical channel group and a value of priority.
